(19) United States
(12) Patent Application Publication
(10) Pub. No.: US 2011/0295758 A1
(43) Pub. Date: Dec. 1, 2011

(54) Neighborhood Networking: Building more prosperous Neighborhoods; methods of defining "Neighborhoods and Moderator"

(76) Inventor: Johnny Keith Wotawa, Moorpark, CA (US)

(21) Appl. No.: 12/802,028

(22) Filed: May 28, 2010

(51) Int. Cl. G06Q 50/00

(52) U.S. Cl. 705/313

(57) ABSTRACT

Neighborhood Networking: Building More Prosperous Neighborhoods wishes to give notice to the nature of the technical disclosures of our invention pertaining to the method of defining “Neighborhood” and “Moderator”. We have discovered through our plan of operation for Neighborhood Networking, that when a “Neighborhood” is made up of only those homes that exist within their own tract as per county records, and does not include any homes within “other” tracts, it creates a group of homes with the most similar characteristics and commonalities. Additionally, we discovered that by implementing a dedicated “Moderator” per “Neighborhood” utilizing the Neighborhood Networking model plan of action, versus several people, the goal of “Building More Prosperous Neighborhoods within Neighborhood Networking, are much more easily accomplished. This is a very simple discovery, one which is obvious, however is not being utilized by any other neighborhood networking or neighborhood community groups.

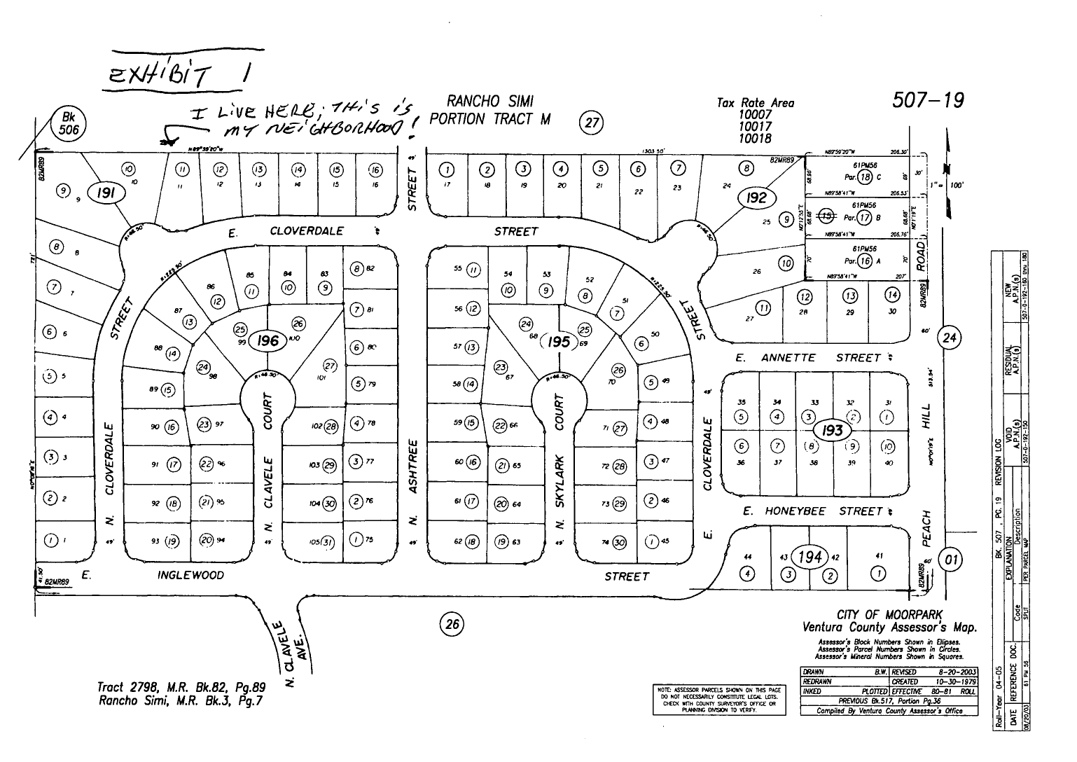

Neighborhood Networking: Building More Prosperous Neighborhoods has adopted and put to use a way of describing and isolating a single neighborhood by defining it as “the homes that exist within the same current tract as defined by the local Tax Assessor or city building office. Also for purposes having to do with the utilization of Neighborhood Networking: Building More Prosperous Neighborhoods, the term “Moderator” is used to describe the single person who alone facilitates the Neighborhood Networking strategy within a specific “Neighborhood”. For more details on the Neighborhood Networking strategy, please see Exhibit 2, “The Founders Story”.

For example (see map exhibit 1 attached): the home that I live in rests within tract #2798 of the Rancho/Simi portion tract map, and is one of 105 homes that also exist within that same tract. For purposes that will be outlined in more detail later, Neighborhood Networking defines this particular “Neighborhood” as the 105 homes that exist within that same tract #2798. Similarly, each tract in each city, county, and state are comprised of a specific group of homes within that tract, some with more than 105 homes, and some with less. Each tract is completely different, as is each individual neighborhood. Thus our method of isolating each neighborhood by it's shared tract number, helps us also focus more on everyone by making groups smaller and communication more effective. I am also the Neighborhood Networking “Moderator” for this particular “Neighborhood”. There can only be one “Moderator” per “Neighborhood”, as defined by Neighborhood Networking: Building More Prosperous Neighborhoods. For a more clear description of “Neighborhood” and “Moderator”, please see Exhibit 2 “The Story from the Founder”

### BACKGROUND OF THE INVENTION

I discovered the value of defining neighborhoods by the tract that they reside in primarily due to my experience in real estate and lending industry and found that one major aspect of prosperity in any neighborhood is the value of the real estate. One key factor in the valuation of real estate is recently sold comparables to ones own home. The best comparables to your own home are usually the homes within the same tract as yours. Members of Neighborhood Networking can only be a member of the “Neighborhood” they live in as defined by Neighborhood Networking as, “the tract they reside in”. This is critical to the success of each individual neighborhood because it allows Neighborhood Networking to isolate specific neighborhoods and focus on creating prosperity within those neighborhoods, one neighborhood at a time. This type of focus helps create many small groups who know exactly how to make their own neighborhood prosperous. The “Moderator” of each “Neighborhood” is equally important and is the single individual responsible for facilitating the Neighborhood Networking strategy within their “Neighborhood”.

### BRIEF SUMMARY OF INVENTION

Neighborhood Networking: Building More Prosperous Neighborhoods, brings people together to network in their own neighborhoods. Neighborhood Networking defines a “Neighborhood” as the neighborhood where a person lives as detailed by their homes tract map located at the city or tax assessors office of that county. The object is to unite neighbors, network with neighbors, using the products and services of neighbors within their immediate tract, so value can be put back in your own neighborhood. It is for the purpose of creating more prosperous neighborhoods. If everyone was allowed to be members of Neighborhood Networking in neighborhoods “other” than where they actually reside (which is where most social and neighborhood websites and functions have gone wrong), then money, products, services, ideas, safety issues, jobs, etc. would potentially go to someone else's neighborhood instead. Those people “not” listed in our tract of homes which defines our neighborhood, can create their own neighborhood on our Neighborhood Networking website, and it will consist of “only” those homes in the tract map of their own home as per the city or tax assessors office in the county they reside. So for purposes having to do specifically with the operations of Neighborhood Networking: Building More Prosperous Neighborhoods”, we have invented the defining of “Neighborhood”, as the group of homes within the tract map as per the city or tax assessor of the county in which they reside. We have also invented the term “Moderator” for purposes only having to do with the operation of Neighborhood Networking: Building More Prosperous Neighborhoods, and define said term as “the single individual responsible for facilitating the Neighborhood Networking strategy within their own “Neighborhood”.

### DETAILED DESCRIPTION OF THE INVENTION

Our invention of using the homes within the tract map found at the city or tax assessors office in the county they reside, is really critical to our operation, as it is a key ingredient that we feel is missing from every other similar website or current operation. Up until the operation of Neighborhood Networking in 2004, there were similar sites such as ineighbor.com, and eneighborhoods, but those sites did nothing to create real prosperity to individual neighbors or neighborhoods because they allowed anyone and everyone to join any and every neighborhood whether they lived there or not. We at Neighborhood Networking thought that did not make sense, especially when it came to something so personal and private as others knowing your business! We found that when we made membership only available to those people who had the common interest of living in the same tract of homes, members were much more likely to join, communicate, and most importantly, prosper! This was proven in our first model neighborhood and so we feel it is extremely important since we have discovered this very critical aspect of our success in creating prosperity within individual neighborhoods, that we attempt to patent our exclusive process of defining a neighborhood as the homes that exist within the tract map found at the city of tax assessors office in the county in which they reside. We also feel it equally important to patent our exclusive process of defining “Moderator” as “the single individual responsible for facilitating the Neighborhood Networking strategy within their own “Neighborhood”. If others were allowed to do this as well, our success would be limited and our invention would not be protected.

1. We claim that we are the first neighborhood networking or any other organization to define and isolate neighborhoods by the tract map that they are located on as per defined at the city or tax assessor in the county in which they reside. We have found no one else who defines, isolates, categorizes, or separates, “neighborhoods” in this way. We have also found that by doing this and utilizing this method of defining a “Neighborhood”, it has become critical to the current and especially the future success of Neighborhood Networking: Building More Prosperous Neighborhoods, as it is the first such website dedicated to truly creating prosperity, one neighborhood at a time. We also claim that we invented the use of “Moderator” as “the single individual responsible for facilitating the Neighborhood Networking strategy within their own “Neighborhood”. (Also, see attached exhibit 2 titled NEIGHBORHOOD NETWORKING STORY.)
